(19) United States
(12) Patent Application Publication
(10) Pub. No.: US 2017/0231044 A1
(43) Pub. Date: Aug. 10, 2017

(54) A MODULE DRIVE AND DRIVING METHOD

(71) Applicant: PHILIPS LIGHTING HOLDING B.V., EINDHOVEN (NL)

(72) Inventors: Junhu LIU, EINDHOVEN (NL); Xiao SUN, EINDHOVEN (NL); Shan WANG, EINDHOVEN (NL); Xinghua HU, EINDHOVEN (NL)

(21) Appl. No.: 15/503,417

(22) PCT Filed: Aug. 10, 2015
(86) PCT No.: PCT/EP2015/068321

§ 371 Date: Feb. 13, 2017

(30) Foreign Application Priority Data
Aug. 15, 2014 (CN) PCT/CN2014/084549
Oct. 3, 2014 (EP) 14187663.1

(51) Int. Cl. H05B 33/08; H05B 37/02

(52) U.S. Cl. CPC H05B 33/0842; H05B 33/0815; H05B 37/0281

(57) ABSTRACT

A driver is able to drive an analog interface module or a digital interface module, for example an LED module. A set of output pins is for connection to the module, with the same set of output pins used for an analog interface LED module as for a digital interface LED module. A detecting circuit detects whether the module is an analog module or a digital module, based on a signal at a control pin. The configuration of the driver is then set accordingly using an analog drive signal or using a digital communication interface for the LED module parameter collection. The driver further comprises a first switching circuit (20) for switching a supply voltage (V) to the power supply pin (VCC), and a second switching circuit (30) for coupling a supply voltage (V) to the control pin through a resistor (R6), wherein the detecting circuit (16) is configured to determine that the module is digital when the first switching circuit (20) supplies the supply voltage (V) to the power supply pin and the second switching circuit (30) isolates the supply voltage (V) from the control pin.

### FIELD OF THE INVENTION

This invention relates to a driver for driving a module, such as a lighting module.

### BACKGROUND OF THE INVENTION

LED lighting is transforming the lighting industry, such that light products are no longer merely on/off devices, but have become sophisticated devices with more elaborate control options, made possible by the easy controllability of LEDs.

The required current to be supplied by a driver varies for different lighting units, and for different configurations of lighting unit. The latest LED drivers are designed to have sufficient flexibility that they can be used for a wide range of different lighting units, and for a range of numbers of lighting units. For this purpose, an intelligent electronic driver in a LED lighting fixture (often called “ballast”) is now frequently separate from the light module itself, to enable this flexibility in the design of a lighting system.

It is known for the driver to operate within a so-called “operating window”. An operating window defines a relationship between the output voltage and output current that can be delivered by the driver. Providing the requirements of a particular lighting load fall within this operating window, the driver is able to be configured for use with that particular lighting load, giving the desired driver flexibility. This means a driver is able to be used for LED units of different design and from different manufacturers and for a wide range of applications, providing that the required current and voltage setting fits the operating window. It also enables lighting generation upgrades without changing the driver.

The driver needs to have its output current set to the desired level within its operating window. This can be achieved by programming the driver to deliver a specific current.

However, an alternative solution which enables a less complicated interface for the user is to provide current setting using a setting component, such as a resistor, outside the driver. This setting resistor can for example be placed on a PCB which provides the interface between the driver and the LED terminals, or the resistor can be integrated as part of a connection cable or connector unit.

The value of the current setting resistor (or other component) is measured by the driver, which can then be used to configure its output accordingly, so that the output current is determined by the resistance value. Once the current has been set, the voltage delivered by the driver will vary depending on the load presented to it (since the LEDs are current driven), but the driver will maintain this voltage within the operating window.

A lighting module of this type is referred to as an analog module, and there is an analog interface, with the lighting module having a passive component with a value which indicates its power requirement. One example of such driver and associated analog lighting module is the Philips Xitanium driver and the Philips Fortimo lighting module.

An alternative approach is for the driver and the lighting module to be equipped with a digital communication interface so the driver asks the lighting module for load information via the bus using a digital communications protocol. The required power is then delivered to the lighting module. There is a communication port on both the driver and lighting module side, which together define a digital interface. The module is referred to as a digital module.

It has been recognized that a standalone driver should also have sufficient flexibility to be used with both analog and digital lighting module. One approach to achieve this is to provide separate output pins on the driver, one set for connection to an analog module and another set for connection to a digital module. Different pins are used for the communication signals, whereas shared pins can of course be used for any fixed voltages supplies, such as a high voltage rail and ground.

To enable one driver to work with the different types of lighting module, there must be a mechanism to let the driver understand the lighting module load requirement. For the example in the above, this detection is performed by knowing the interface which is used to connect the driver and lighting module. If the lighting module is connected to an analog interface, the driver must communicate with the lighting module using an analog protocol. If the lighting module is connected to a digital interface, the driver must communicate with the lighting module using a digital protocol. As the driver contains both digital and analog interfaces, there is an increase in the connector pin count. This increases the number of wires and increases the overall cost, and also makes connection complex.

### SUMMARY OF THE INVENTION

The drawback of the prior drivers is excessively many pins respectively for the analog module and digital module. It would be advantageous to reduce the number of pins by designing common pins to both types of modules. It would also be advantageous to design an automatic mechanism to determine the type of module that is connected via the common pins. To better address these concerns, the invention is defined by the claims.

WO2011067177A1 discloses a converter that can distinguish a simple LED module and an intelligent LED module by detecting the voltage amplitude on a data line, since the electronic switch that pull low the data line in the intelligent LED module and the resistor 402 that delivers the control parameter in the simple LED module has different resistance.

It would better to provide a more accurate solution of distinguishing different types of modules.

According to an aspect of the invention, there is provided a driver able to drive an analog module or a digital module, the driver comprising:

a set of output pins, adapted to be connected to an external module, comprising at least a power supply pin, a ground pin and a control pin, wherein the same set of output pins is used for connection to an analog module as adapted to be connected to a digital module;

a detecting circuit adapted to detect whether the module is an analog module or a digital module, based on a signal at the control pin;

a first switching circuit for switching a supply voltage to the supply pin, and

a second switching circuit for coupling a supply voltage to the control pin through a resistor,

wherein the detecting circuit is configured to determine that the module is digital when there is a voltage above a first percentage of the supply voltage detected at the control pin, when the first switching circuit supplies the supply voltage to the power supply pin and the second switching circuit isolates the supply voltage from the control pin.

This arrangement makes use of a control pin to detect the type of device being driven, in particular to distinguish between an analog module and a digital module. This means the driver can be used to drive an analog module requiring control using an analog interface or a digital module requiring control using a digital communications interface. However, the same set of output pins are used to connect to either type of device. This can reduce the number of pins needed as well as reducing the chance of making incorrect connections between the driver and module. Moreover, as long as a substantial voltage is present, the driver can determine it is a digital module, there is no need to obtain the accurate value and the detecting error or component variance would no influence the result. Preferably, the first percentage is 80% of the supply voltage so as to indicate the substantial supply voltage is present.

This provides a single interface on the driver side which is able to automatically detect the interface on the module side and then adaptively match that interface. In this way, the driver side uses only one set of pins and wires for either a digital or an analog interface.

The first switching circuit can be used to provide power to the connected module. The coupling of this supply means that the resulting signal on the control pin differs as between a digital and analog module, so that the type of module can be detected. The second switching circuit can be used for providing power to a level setting component of the module, to enable the value to be read out, when an analog module has been detected.

The module may be an input device, such as a sensor, or an output device, such as a lighting module. In general, the embodiment of the invention enables the number of connection terminals to be reduced so that a driver is made flexible and can communicate with either type of module using a shared set of connection terminals. All connection terminals are used when connecting to an analog device or to a digital device. This reduces confusion and reduces the likelihood of incorrect connections, since for both types of connection, all terminals have a function.

The control pin may be used for the communication with the module after the detection, wherein the control pin is adapted to communicate clock signal for a digital module when the module is determined as digital, or adapted to communicate a resistance information for an analog module when the module is determined as analog.

Thus, when driving the module, the control pin used for detecting the type of device is also used for both the analog and digital driving. In this way, the number of pins required at the output of the driver is kept to a minimum. At least one shared pin (in addition to pins that carry voltage levels such as VCC and ground) functions as a control line to a digital module or an analog module as well as a testing pin.

The driver may be for driving a lighting module, wherein the control pin is adapted to be connected to a digital communication interface clock signal port of a digital lighting module when the module is as digital or to a level setting port of an analog lighting module when the module is as analog.

The level setting port of an analog lighting module for example provides a mechanism by which the lighting module can inform the driver of its characteristics, so that the driver can supply a suitable drive signal. The clock signal port of a digital lighting module receives the clock signal which controls the timing of the digital communications interface.

There may be at least two supply pins, for example as the positive and negative polarities, for connection to opposite sides of a lighting element of the lighting module.

The driver further comprises a configuration unit adapted to set the configuration of the driver in response to the detection, the driver being configurable to communicate with the module using an analog interface or using a digital communication interface in dependence on the detection.

In this embodiment, the driver can be adaptively configured to as to communicate with the determined type of module.

The detecting circuit may for example further be configured to: determine that the module is analog when a part of said supply voltage is detected at the control pin when the second switching circuit couples the supply voltage to the control pin through the resistor, wherein the detecting circuit determines said part of said supply voltage at the control pin when a voltage detected at the control pin is smaller than a second percentage of the supply voltage.

Further, the detecting circuit is configured to determine an open circuit when said supply voltage is detected at the control pin when the second switching circuit couples the supply voltage to the control pin through the resistor, wherein the detecting circuit determines said supply voltage at the control pin when a voltage detected at the control pin is bigger than a third percentage of the supply voltage.

Thus, by controlling the switching of the supply voltage to the supply pin, it becomes possible to detect the type of attached module. Further, by controlling the switching of the supply voltage to the control pin, it becomes possible to even detect when no module is connected.

Preferably, the second percentage is 50% and the third percentage is 80%.

The driver may have a second control pin, for connection to a digital communication interface data signal port of a digital lighting module or to a temperature detection pin of an analog lighting module.

This arrangement enables two control pins to be used for the connection to a digital module or to an analog module. By sharing two control pins, it becomes possible for all pins to be shared. There may for example be five pins in total—two supply pins for connection to opposite ends of the LED or LED string, a ground pin, and the two control pins defined above.

An aspect of the invention also provides a digital lighting module, comprising:

a supply port adapted to connect to a power supply pin of a driver;

a digital interface clock signal port coupled to the supply port through a pull up resistor, and adapted to connect to a control pin of the driver, and;

a ground port adapted to connect to the ground pin of the driver;

wherein said digital lighting module is for use with a driver according to above aspect, and a voltage is present at the digital interface clock signal port so as to indicate the module is digital when said supply port is adapted to receive a supply voltage from the supply pin and the digital interface clock signal port is adapted to receive no supply voltage from the control pin.

This provides a digital lighting module suitable for use with the driver of the invention to make it distinguishable from an analog lighting module.

The digital lighting module may further comprise a digital interface data signal port adapted to connect to a second control pin of the driver.

An aspect of the invention also provides a lighting arrangement comprising:

a driver according to the above embodiments of the invention; and

a digital lighting module according to the above embodiments of the invention, or an analog lighting module having a setting port adapted to connect to the control pin of the driver, a ground port adapted to connect to the ground pin of the driver, and a setting impedance between the setting port and the ground port.

This provides the driver together with a digital lighting module or an analog lighting module.

Another aspect of the invention provides a method of driving an analog module or a digital module, the method comprising:

connecting a set of output pins of the driver to the module, comprising at least a supply pin, a ground pin and a control pin;

using the control pin to detect whether the module is an analog module or a digital module;

setting the configuration of the driver in response to the detection; and

using the driver to communicate with the module using an analog interface or using a digital communication interface in dependence on the detection, wherein the same set of output pins is used for connection to an analog module as for connection to a digital module;

wherein the step of using the control pin to detect comprises:

switching a supply voltage to the supply pin and isolating the supply voltage from the control pin;

sampling a voltage on the control pin to detect whether the module is an analog module or a digital module, wherein determining that the module is digital when there is a voltage detected at the control pin.

The control pin may also be used for the communication with the module after the detection.

This method makes use of a control pin for detection of the type of connected module as well as for subsequently driving the module. This reduces the number of connections between the driver and the module.

The method may comprise:

if the module is detected to be an analog module, measuring a setting impedance using the control pin and driving the analog module to a level based on the measured impedance; and

if the module is detected to be a digital module, connecting the control pin to the supply voltage through a resistance and using the control pin to provide digital communication interface clocking to the module.

Sampling a voltage on the control pin may further comprise detecting if no load is connected to the driver.

If the module is detected to be an analog module, a temperature sensing signal may be received at the driver from the module using a second control pin; and if the module is detected to be a digital module, digital communication interface data may be provided to the module using the second control pin.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1(a) shows a driver connected to a digital lighting module and FIG. 1(b) shows the same driver connected to an analog lighting module;

FIG. 2 shows simplified circuit diagrams for the driver and the two types of lighting module;

FIG. 3 is used to explain the method of determining the type of lighting module and driving it accordingly; and

FIG. 4 shows the method explained with reference to FIG. 3.

### DETAILED DESCRIPTION OF THE EMBODIMENTS

The invention provides a driver able to drive an analog module or a digital module. A set of output pins is for connection to the module, with the same set of output pins universally used for an analog module as for a digital module. A detecting circuit detects whether the module is an analog module or a digital module, based on a signal at a control pin in various detecting conditions. The configuration of the driver is then set accordingly using an analog drive signal or using a digital communication interface.

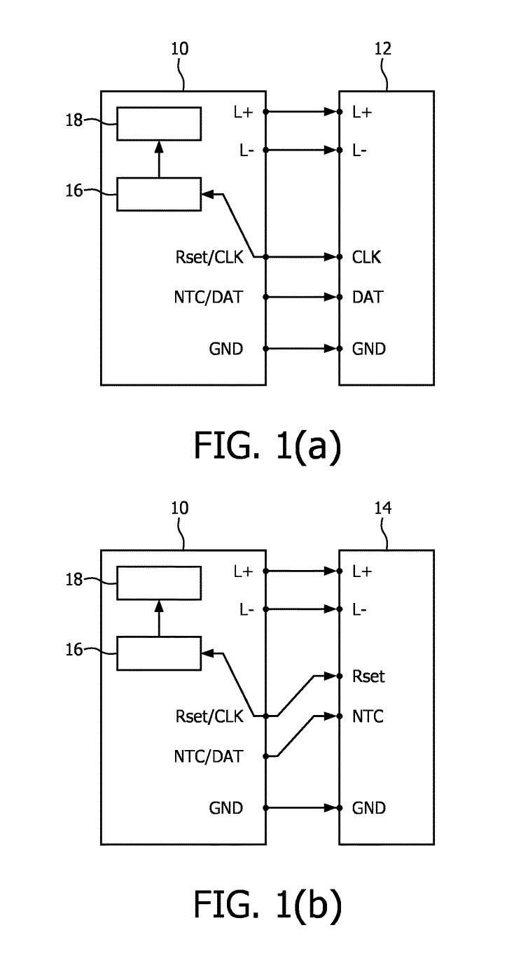

FIG. 1 shows a driver 10 able to drive an analog module or a digital module. FIG. 1(a) shows the driver 10 driving a digital lighting module 12 and FIG. 1(b) shows the driver driving an analog lighting module 14.

The driver has a set of output pins, for connection to the module, comprising a pair of supply pins L+ and L−. These are for example for connection to opposite ends/electrodes of a string of LEDs. The driver further has a ground pin GND, a first control pin Rset/CLK and a second control pin NTC/DAT.

As can be seen, the same set of output pins is used for connection to the analog module as for connection to the digital module. For clarity, the connections on the driver are referred to as pins, and the connections on the modules are referred to as ports, but not difference in meaning is intended.

The driver has a detecting circuit 16 for detecting whether the module is an analog module or a digital module, based on a signal at the control pin Rset/CLK.

A configuration unit 18 is provided for setting the configuration of the driver in response to the detection, the driver being configurable to communicate with the module using an analog interface or using a digital communication interface in dependence on the detection.

The digital interface on the digital module 12 comprises ports for the signals L+ and L− provided to the LED string as well as a digital interface clock signal port CLK and a digital interface data signal port DAT. The control pin is thus for connection to a digital communication interface clock signal port CLK. The data signal can convey information about the type of lighting module as well as other data such as temperature sensing data.

The analog interface on the analog module 14 comprises ports for the signals L+ and L− provided to the LED string as well as the signals providing measurement of an analog level setting component. The port on the analog module for providing the level setting information is the port Rset. In addition, the analog module has a temperature sensor in the form of a negative temperature coefficient (NTC) component. The NTC information is provided to a port NTC. This temperature detection is used by the driver to provide a thermal compensation and/or cut out function.

In the example shown, the control pin Rset/CLK is used for detection of the type of module as well as subsequently as part of the digital or analog interface. However, a separate control pin could be used. Also, there may be modules with only a high voltage and ground, and which do not need separate supply ports L+ and L−.

The advantage of the five-pin structure of the driver in FIG. 1 is that many existing types of analog and digital module already have the two control pins and the other three supply pins.

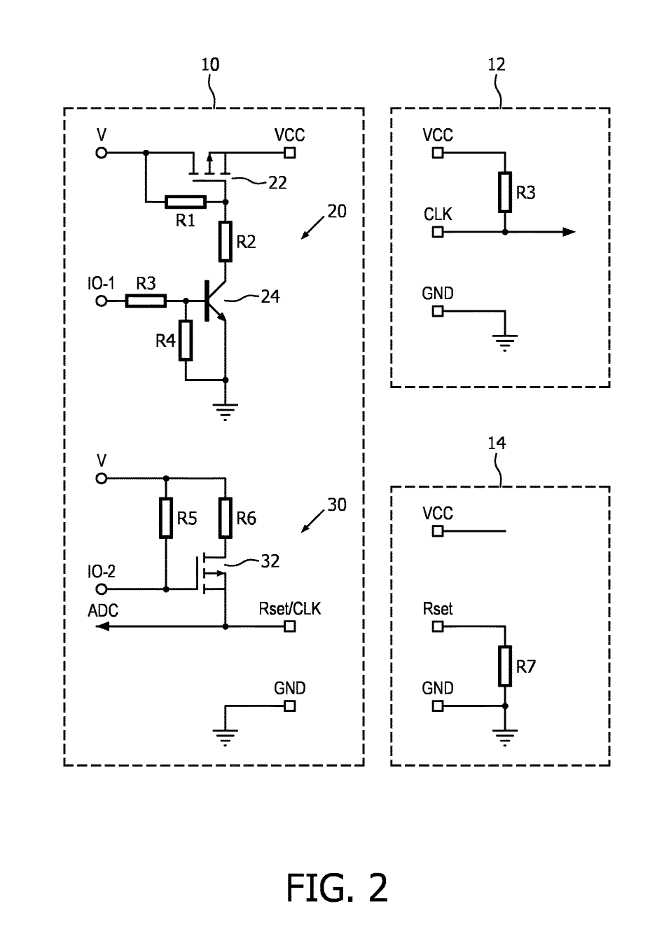

FIG. 2 is used to explain the circuitry used in the driver and in the digital and analog modules to enable the detection of the type of module. FIG. 2 shows a single supply voltage VDD (instead of L+ and L−). The detection is based on the Rset/CLK pin, so the circuitry connected to the DAT/NTC port and to the DAT and NTC pins is not shown.

The driver comprises a first switching circuit 20 for switching a supply voltage V to the supply pin VCC using a controllable switch, in particular in the example shown a MOSFET 22. The switching circuit is controlled by a first input/output connection IO.1 which is accessed by the main control circuitry within the driver. The pin of IO.1 controls the gate voltage of a transistor 24. When turned on, it pulls down the gate voltage of MOSFET 22 through resistor R 2 to turn it off and isolate the power supply pin VCC from the input supply V. When transistor 24 is turned off by a low input IO.1, the gate of MOSFET 22 is pulled high through resistor R 1 and it is turned on, and in turn the voltage on the power supply pin is the supply voltage. A second switching circuit 30 is for coupling the supply voltage V to the control pin Rset/CLK through a resistor R6 and MOSFET 32. The second switching circuit is controlled by a second pin of IO.2 which is again accessed by the control circuitry within the driver. When the IO.2 is high, the MOSFET 32 is turned on and the resistor R6 is connected between the input supply V and the control pin Rset/CLK. The base current is sourced from the supply V through resistor R5 rather than from the pin IO2. When the input IO.2 is low, the MOSFET 32 is turned off and the supply voltage is not coupled to the control pin Rset/CLK.

In the aspect of connection with analog modules, the control pin is used as the Rset pin and it functions as an input for receiving information from the lighting module, and the signal on the control pin is coupled to an analog to digital converter to enable the signal level on the pin to be measured. In the aspect of connection with digital modules, the control pin as CLK pin functions as an output to provide the clock signal to the digital module.

The circuits 20 and 30 together function as control and detection logic, with the input/output terminals IO.1 and IO.2 controllable using outputs from the master control unit of the driver (not shown).

The digital lighting module 12 has a pull up resistor R 3 between the clock input CLK and the supply line VCC. Thus, it has a pull up clock signal, which pulls high an open-drain clock signal. Otherwise, the other aspects of the digital lighting module can be entirely conventional.

The analog lighting module 14 can be entirely conventional, and has a setting resistor R7 between the Rset port and ground. There is no coupling between the supply VCC and the setting resistor.

Note that while this example makes use of the shared Rset/CLK pin for detection, the same approach can be used based on the shared DAT/NTC pin. In this case, the digital data signal is in the form of a pull-up open drain data signal.

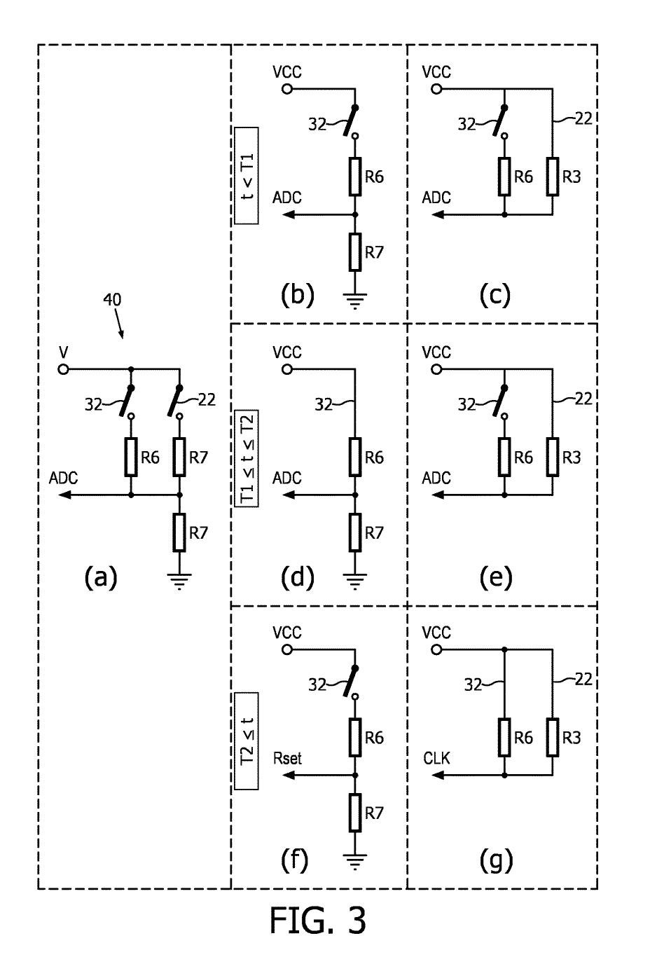

FIG. 3 shows the different settings for the driver circuit. An equivalent circuit 40 is shown in FIG. 3(a), which represents the function of the driver as well as the relevant components of both the analog and digital lighting modules.

The driver is able to distinguish an analog lighting module, a digital lighting module, or no device connected to the driver.

The following table shows the analog to digital converter sampling value for different control of the MOSFETs 32 and 22 during the power on stage of the light fixture. The table shows the sampled value for an analog lighting module, a digital lighting module and an open circuit:

TABLE 1

| | 22 = On/32 = Off | 22 = On/32 = On |
|---|---|---|
| ADC value (analog) | 0 | R7/(R7 + R6)*VCC |
| ADC value (digital) | VCC | VCC |
| ADC value (open circuit) | 0 | VCC |

This operation can be understood from the equivalent circuit 40. When an analog module is connected, R3 is an open circuit, and when a digital module is connected, R7 is an open circuit.

The detecting process can thus have the following steps:
(i) The driver turns on MOSFET 22 and turns off MOSFET 32. If “VCC” is sampled by the analog to digital converter at the control pin, then a digital module is connected. The driver sets the interface to digital mode by manipulating MOSFET 32 to provide the clock signal. In this way, R6 works as a pull high resistor for the digital interface open-drain signal CLK. The data signal DAT is provided over the second control pin. Practically, a voltage no less than an 80% percentage of the VCC can be deemed as the substantial VCC.
(ii) If the analog to digital converter samples a 0, the transistor 24 turns on MOSFET 32. More practically, a voltage less than 20% of the VCC can be deemed as substantial zero. After the MOSFET 32 is turned on, if the analog to digital converter samples a voltage ≠VCC, it means there is an analog module. The driver calculates the R 7 value using the sampled value and the formula in table 1. Based on the calculated value of R 7, it determines the rating of the analog module such as operating current, and outputs the associated current to drive the analog module. The NTC temperature sensor component can also be read out using the second control line. Practically, a voltage less than an 80% percentage of the VCC can be deemed as voltage ≠VCC; more practically, to increases a safety margin, a voltage less than 50% percentage of the VCC can be deemed as voltage ≠VCC.
(iii) If the analog to digital converter samples a value VCC in step (ii), it means there is not a module connected to the driver. This is an abnormal condition and the driver will not output any driving current. Practically, a voltage no less than an 80% percentage of the VCC can be deemed as the substantial VCC.

In a more simplified application, the absence of the module is not considered. Thus in step (i), if VCC is sampled, a digital module is determined; otherwise an analog module is determined.

FIG. 3 shows the various possibilities at different time points. The first row, of FIG. 3(b) and Figure (c), is for a first time period t<T1.

The second row, of FIG. 3(d) and Figure (e), is for a second time period T1<t<T2.

The third row, of FIG. 3(f) and Figure (f), is for a third time period t>T2. This is when the detection and configuration is complete and the lighting module is being driven.

The left column of FIGS. 3(b), (d) and (f) shows the equivalent circuit when an analog module is connected. The right column of FIGS. 3(c), (e) and (g) shows the equivalent circuit when a digital module is connected.

In the initial time period of FIGS. 3(b) and (c), a supply voltage is switched to the supply pin VCC by switch 22 but the supply voltage is isolated from the control pin by opening MOSFET 32.

In FIG. 3(b), there is no resistor R3 so even through switch 22 is closed, there is no connection made to the control pin. Switch 32 is open. The control pin is simply grounded through the setting resistor R7. The analog to digital converter will sample a “0” voltage level.

In FIG. 3(c), resistor R3 couples the supply voltage to the control pin. There is no resistor R7. The analog to digital converter will sample a VCC voltage level.

Thus, it can be determined if the module is an analog module or a digital module based on the detection of 0V or VCC.

Switch 32 is then closed.

In FIG. 3(d), the analog to digital converter will then sample the resistor R7 giving a non-zero value defined by the resistive divider of R6 and R7. The sampled voltage is determined by:

V_{ADC}=VCC*R7/(R7+R6)

In FIG. 3(e), there is no need for a measuring step, so the configuration is the same as in FIG. 3(c).

In FIG. 3(f), the analog module is driven according to the sampled and calculated value of R7. This analog resistor value is used to deliver a desired power, such as a constant current value.

In FIG. 3(g) the driver turns on MOSFET 32 to use resistor R 6 as a pull high resistor for the CLK signal in the digital interface. The driver controls the module according to the communication results between the driver and module over the digital communications interface.

Note that the grounded control pin in FIG. 3(b) can also indicate that no module is attached. When the driver turns on MOSFET 32 as shown in FIG. 3(d) the analog to digital converter will sample a value VCC instead of sampling the resistor divider voltage. Thus, a voltage VCC is indicative that there is no lighting module connected. The driver will not output a current as there is not a load; Thus, it can be seen that the detecting circuit is configured to determine that the module is digital when there is a voltage detected at the control pin, when the supply voltage is supplied to the supply pin through resistor R3 but the supply voltage is not switched to the control pin through MOSFET 22.

It will determine that the module is analog when a part (the resistor divider network) of said supply voltage is detected at the control pin when the supply voltage is switched to the control pin by MOSFET 32.

It will determine an open circuit when said supply voltage is detected at the control pin when the supply voltage is switched to the control pin by MOSFET 32.

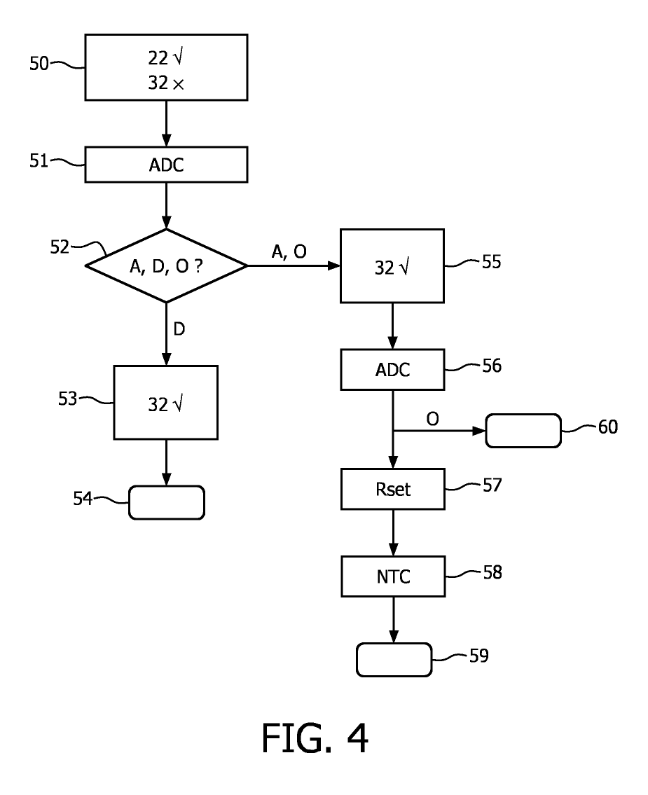

FIG. 4 shows the method steps as explained above.

In step 50, switch 22 is closed and switch 32 is opened. The supply voltage is provided to the supply pin. The control pin signal is sampled in step 51, and from this it is determined in step 52 if the module is digital (D) or analogue or open circuit (A, O).

For a digital module, the switch 32 is closed in step 53 to configure resistor R 6 as a pull up resistor, and the communication and driving takes place using the digital communications protocol in step 54.

For a non-digital module, the switch 32 is closed in step 55 to couple the supply voltage to the control pin through the resistor, so that a further measurement of the control pin voltage can take place in step 56. This then enables the method to distinguish between an analog module and an open circuit. For an analog module, the setting resistor value is determined in step 57 and optionally an NTC temperature sensor measurement is obtained in step 58 before analogue driving in step 59. If an open circuit (O) is detected after signal sampling in step 56, the driving is ended in step 60.

The invention can be used for any luminaire, lamps and other lighting fixtures, in which the driver is separated from the light module with feedback from the light module to the driver for driving power control. The invention can be applied to a down lighting module, outdoor luminaire, T-LED etc.

The digital communications interface may comprise the DMX 512 protocol, DALI or I²C, for example.

The analogue interface may for example make use of the 1-10V lighting protocol or an analogue multiplexed system.

In this description and claims, the term “LED” will be used to denote both organic and inorganic LED's, and the invention can be applied to both categories. LEDs are current driven lighting units. They are driven using an LED driver which delivers a desired current to the LED.

The example above relates to the control of lighting modules. However, the invention can also be applied to sensors, for example with an analog or a digital interface. These may comprise occupancy sensors, motion sensors, daylight harvest sensors etc. The driver is then able to detect the connection of an analog sensor or a digital sensor in the same manner as explained above, by making use of a control pin for detecting the different internal circuitry of the analog or digital sensor. The control pin can again then be used as part of the driving interface after the sensor driver has been configured appropriately.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A driver (10) able to drive an analog module (14) or a digital module (12), the driver comprising:
a set of output pins, adapted to be connected to an external module, comprising at least a power supply pin (VCC; L+, L−), a ground pin (GND) and a control pin (Rset/CLK), wherein the same set of output pins is used adapted to be connected to an analog module (14) as adapted to be connected to a digital module (12);
a detecting circuit (16) adapted to detect whether the module is an analog module or a digital module, based on a signal at the control pin;
a first switching circuit (20) adapted to switch a supply voltage (V) to the power supply pin (VCC), and
a second switching circuit (30) adapted to couple the supply voltage (V) to the control pin through a resistor (R6),
wherein the detecting circuit (16) is configured to determine that the module is digital when there is a voltage above a first percentage of the supply voltage (V) detected at the control pin, when the first switching circuit (20) supplies the supply voltage (V) to the power supply pin and the second switching circuit (30) isolates the supply voltage (V) from the control pin.

2. A driver as claimed in claim 1, wherein the first percentage is 80 %, and the control pin (Rset/CLK) is used for the communication with the module after the detection, wherein the control pin is adapted to communicate clock signal for a digital module when the module is determined as digital, or adapted to communicate a resistance information for an analog module when the module is determined as analog.

3. A driver as claimed in claim 1, for driving a lighting module, wherein the control pin is adapted to be connected to a digital communication interface clock signal port (CLK) of a digital lighting module when the module is as digital or to a level setting port (Rset) of an analog lighting module when the module is as analog.

4. A driver as claimed in claim 3 comprising at least two supply pins (L+, L−), adapted to be connected to opposite sides of a lighting element of the lighting module.

5. A driver as claimed in claim 1, further comprising:
a configuration unit (18) adapted to set the configuration of the driver in response to the detection, the driver being configurable to communicate with the module using an analog interface or using a digital communication interface in dependence on the detection.

6. A driver as claim in claim 1, wherein the detecting circuit is further configured to:
determine that the module is analog when a part of said supply voltage (V) is detected at the control pin when the second switching circuit couples the supply voltage to the control pin through the resistor (R6), wherein the detecting circuit determines said part of said supply voltage (V) at the control pin when a voltage detected at the control pin is smaller than a second percentage of the supply voltage (V).

7. A driver as claim in claim 6, wherein the detecting circuit is further configured to:
determine an open circuit when said supply voltage (V) is detected at the control pin when the second switching circuit couples the supply voltage (V) to the control pin through the resistor (R6), wherein the detecting circuit determines said supply voltage (V) at the control pin when a voltage detected at the control pin is bigger than a third percentage of the supply voltage (V), wherein said second percentage is 50% and said third percentage is 80%.

8. A driver as claimed in any one of claims 2 to 6, comprising a second control pin (NTC/DAT), adapted to be connected
to a digital communication interface data signal port (DAT) of a digital lighting module (12) when the module is determined as digital or
to a temperature detection port (NTC) of an analog lighting module (14) when the module is determined as analog.

9. A digital lighting module, comprising:
a supply port (L+, L−) adapted to connect to a power supply pin of a driver;
a digital interface clock signal port (CLK) coupled to the supply port through a pull up resistor (R 3 ), and adapted to connect to a control pin (Rset/CLK) of the driver; and
a ground port (GND) adapted to connect to the ground pin of the driver;
wherein said digital lighting module is for use with a driver as claimed in any one of claims 1 to 8, and
a voltage is present at the digital interface clock signal port so as to indicate the module is digital when said supply port (L+, L−) is adapted to receive a supply voltage from the power supply pin and the digital interface clock signal port (CLK) is adapted to receive no supply voltage from the control pin.

10. A digital lighting module as claimed in claim 9, further comprising a digital interface data signal port (DAT) adapted to connect to a second control pin (NTC/DAT) of the driver.

11. A lighting arrangement comprising:
a driver (10) as claimed in any one of claims 1 to 8; and
a digital lighting module (12) as claimed in claim 9 or 10, or an analog lighting module (14) having a setting port (Rset) adapted to connect to the control pin of the driver, a ground port (GND) adapted to connect to the ground pin of the driver, and a setting impedance (R7) between the setting port and the ground port.

12. A method of driving an analog module or a digital module, the method comprising:
connecting a set of output pins of the driver (10) to the module, comprising at least a power supply pin (L+, L−), a ground pin (GND) and a control pin (Rset/CLK);
using the control pin to detect whether the module is an analog module or a digital module;
setting the configuration of the driver (10) in response to the detection; and
using the driver to communicate with the module using an analog interface or using a digital communication interface in dependence on the detection, wherein the same set of output pins is used for connection to an analog module (14) as for connection to a digital module (12);
wherein the step of using the control pin to detect comprises:
(50) switching a supply voltage (V) to the power supply pin and isolating the supply voltage from the control pin;
(51) sampling a voltage on the control pin to detect whether the module is an analog module or a digital module, wherein determining that the module is digital when there is a voltage detected at the control pin.

13. A method as claimed in claim 12, wherein the control pin is used for the communication with the module after the detection.

14. A method as claimed in claim 12 or 12 for driving a lighting module, the method comprising
connecting the control pin to a digital communication interface clock signal port (CLK) of a digital lighting module when the module is determined as digital or to a level setting port (Rset) of an analog lighting module when the module is determined as analog, and
connecting a second control pin (NTC/DAT) to a digital communication interface data signal port (DAT) of a digital lighting module when the module is determined as digital or to a temperature detection port (NTC) of an analog lighting module when the module is determined as analog.

15. A method as claimed in any one of claims 12 to 14, comprising:
if the module is detected to be an analog module, (57 ) measuring a setting impedance using the control pin and driving the analog module to a level based on the measured impedance; and
if the module is detected to be a digital module, (53 ) connecting the control pin to the supply voltage through a resistance and using the control pin to provide digital communication interface clocking to the module.
